(19) United States
(12) Patent Application Publication
(10) Pub. No.: US 2004/0077916 A1
(43) Pub. Date: Apr. 22, 2004

(54) System and method for radioactive waste vitrification

(76) Inventors: John Gilleland, Rancho Santa Fe, CA (US); Richard L. Freeman, Del Mar, CA (US); Stephen F. Agnew, San Diego, CA (US)

Correspondence Address: NEIL K. NYDEGGER, NYDEGGER & ASSOCIATES, 348 Oliver Street, San Diego, CA, 92103, US

(21) Appl. No.: 10/272,481

(22) Filed: Oct. 16, 2002

(51) Int. Cl. G21F 9/00

(52) U.S. Cl. 588/10

(57) ABSTRACT

A method and system for increasing the waste loading of vitrified nuclear waste includes a plasma mass filter and a heating apparatus. The plasma mass filter is used first to collect radioactive particles from a multi-species plasma. The radioactive particles are then placed, together with a frit, in crucibles. The crucibles are then induction heated to fuse the radioactive elements with the frit to form a melted mixture which is then cooled to form vitrified waste having relatively high waste loading.

### FIELD OF THE INVENTION

The present invention pertains generally to systems and methods for the remediation of nuclear waste. More particularly, the present invention pertains to systems and methods for vitrifying relatively high concentrations of a radioactive nuclear waste. The present invention is particularly, but not exclusively, useful as a system and method for using induction heating to vitrify the output of a plasma mass filter.

### BACKGROUND OF THE INVENTION

One particularly effective technique for disposing of nuclear waste involves a process known as vitrification, or glassification. In a vitrification process, nuclear waste is incorporated into glass by first heating and fusing the nuclear waste with frit. This is typically done in a large conventional melter having electrodes which heat and fuse the nuclear waste with frit. The melted mixture of nuclear waste and frit is then poured into storage canisters for subsequent cooling and disposal.

Present day vitrification techniques, however, face several significant problems. For one, the electrodes of a conventional joule-heated melter can be shorted out by certain components, such as chromium, noble metals or spinel crystals when they are present in the nuclear waste. Unfortunately, electrodes which have shorted out will render the melter inoperable, and essentially shut down the entire vitrification operation. For another, it is always a concern to avoid melt processing accidents such as have occurred when conventional melters have been used.

Another important concern with current vitrification techniques is that, once the waste has been vitrified, heat from the encapsulated radionuclides may cause the glass to fracture, degrade and release radionuclides. Thus, there is a thermal limit as to the amount of radioactive material that can be encapsulated in a volume of glass. Finally, the process of vitrifying unprocessed nuclear waste using conventional techniques may require decades to accomplish because of the large volume of nuclear waste that may be involved.

Insofar as nuclear waste itself is concerned, nuclear waste generally contains a mix of radioactive material, non-radioactive material and glass contaminants. Obviously, it is desirable to differentiate between radioactive material, which requires special handling (i.e. vitrification), and the nonradioactive material and glass contaminants, which can be disposed of in a more conventional manner. Thus, if the radionuclides can somehow be effectively concentrated and separated from the non-radioactive material and contaminants of nuclear waste, the handling and disposal of the radioactive material can be accomplished much more efficiently.

There are many different types of devices that can separate particles of a mixed material. One example is the device disclosed in U.S. Pat. No. 6,096,220 (the Ohkawa Patent), which issued on Aug. 1, 2000 to Ohkawa, for an invention entitled “Plasma Mass Filter” and which is assigned to the same assignee as the present invention. Briefly, the plasma mass filter, as disclosed in the Ohkawa Patent, relies on crossed electric and magnetic fields that are established in a chamber to place charged particles on different predictable orbital paths. This is done to separate the charged particles from each other. Specifically, charged particles having relatively low mass to charge ratios are confined inside the chamber during their transit of the chamber. On the other hand, charged particles having relatively high mass to charge ratios are not so confined. Instead, these high-mass particles (M₂) are collected inside the chamber wall before completing their transit through the chamber.

It happens that under present vitrification practices, i.e. using conventional melters which do not incorporate the teachings of the Ohkawa Patent, only a relatively small mass percentage of radionuclides will be encapsulated in a given mass of glass. By way of example, consider the fact that presently, only about 15% by weight of the Hanford nuclear waste that is being processed is of mass greater than 90. However, when this waste is vitrified using conventional vitrification techniques, it constitutes about 33% by weight of the vitrified waste. The result here is that less than 5% of the atoms in the vitrified waste are radioactive. Thus, recognizing higher waste loadings may be possible, and keeping in mind that the thermal limit is the best that can be done, it is apparent that more highly concentrated nuclear waste and more efficient vitrification techniques are desirable. An objective here is to achieve effectively higher waste loadings (i.e. the amount of radioactive material in a volume of glass).

In light of the above, it is an object of the present invention to provide a system and method for using induction heating to vitrify relatively high concentrations of radioactive nuclear waste. It is another object of the present invention to provide a system and method for increasing the waste loading of vitrified waste. Still another object of the present invention is to provide a system and method for separating radioactive elements from non-radioactive elements to obtain a relatively high concentration of radioactive nuclear waste. Yet another object of the present invention is to provide a system and method for vitrifying relatively high concentrations of radioactive nuclear waste by using a plurality of disposable crucibles that can be heated to higher temperatures for a shorter period of time to accelerate a vitrification process. Still another object of the present invention is to provide a system and method which is easy to use, relatively simple to implement, and comparatively cost effective.

### SUMMARY OF THE INVENTION

A system and method for increasing the waste loading of disposable radioactive nuclear waste relies on the general notion that, in addition to other constituents, radioactive waste contains radionuclides having relatively high atomic weights. Accordingly, when nuclear waste is vaporized and ionized to create a multi-species plasma, the resultant multi-species plasma will include charged particles having relatively low mass to charge ratios (M₁) and charged particles having relatively high mass to charge ratios (M₂). This multi-species plasma can then be injected into the chamber of a plasma mass filter, such as the one disclosed in the Ohkawa Patent, which is incorporated herein by reference. In accordance with the teachings of the Ohkawa Patent, the multi-species plasma interacts with the crossed magnetic and electric fields inside a chamber to eject high-mass particles (M₂) into the wall surrounding the chamber. On the other hand, the low-mass particles (M₁) are confined inside the chamber. They do not collide with the chamber wall and, instead, are allowed to transit the chamber. Thus, the particles are separated. After the high-mass particles (M₂) have been separated from the low-mass particles (M₁) in this manner, the high-mass particles (M₂) are collected from the chamber wall of the filter for subsequent vitrification. For the present invention, it is envisioned that more than 70% of the material collected from the chamber wall will be radioactive high-mass particles (M₂).

In accordance with the present invention, once the high-mass particles (M₂) have been collected from a plasma mass filter chamber, they are vitrified at a sufficiently high temperature to ensure high mass loadings can be achieved. Two attractive approaches to this high temperature vitrification are available: cold wall crucibles or single use crucibles. By using a plurality of crucibles, the design can be simplified since multiple usage is not required. For the individual crucibles, each crucible is structurally shaped as a cup or receptacle which has a compartment or hollow cavity for receiving the nuclear waste. In this structure, the cavity is surrounded by a wall which has an inner layer of alumina, an intermediate layer of graphite and an outer layer of stainless steel. Additionally, at least one induction coil is mounted on the outer surface of each crucible.

In the operation of the present invention, along with the high-mass particles (M₂), frit is placed in each crucible. Each crucible is then heated by its induction coils to approximately 1600° C. In this process, the high-mass particles (M₂) fuse with the frit to form a melted mixture having a relatively high waste loading (as much as 66%). This mixture is then cooled in the respective crucibles to form vitrified nuclear waste. These crucibles containing vitrified nuclear waste can then be subsequently discarded.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a plasma mass filter with portions broken away for clarity;

FIG. 2 is a exploded perspective view of a heating apparatus in accordance with the present invention with a disposable crucible of the present invention separated therefrom; and

FIG. 3 is a cross-sectional view of a crucible as seen along line 3-3 in FIG. 2.

### DESCRIPTION OF THE PREFERRED EMBODIMENTS

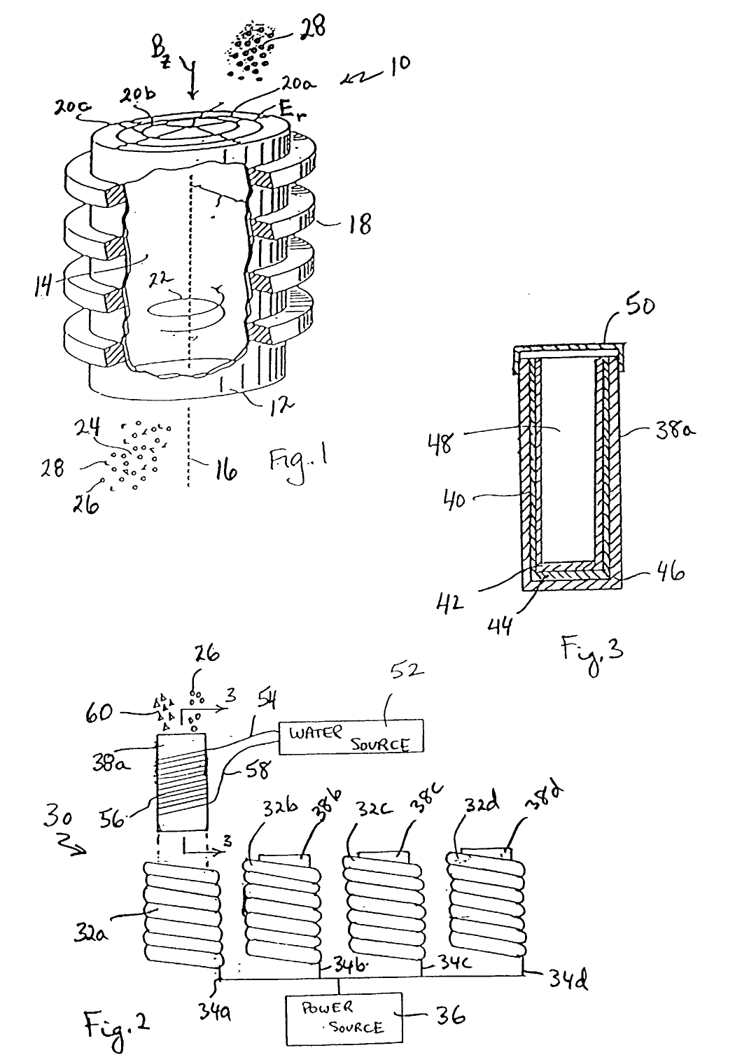

Referring to FIG. 1, a plasma mass filter for use with the present invention is shown and generally designated 10. As shown, the filter 10 includes a substantially cylindrical shaped wall 12 which surrounds a chamber 14, and defines a longitudinal axis 16. The filter 10 also includes a plurality of magnetic coils 18 which are mounted on the outer surface of the wall 12 to surround the chamber 14. In a manner well known in the pertinent art, the coils 18 can be activated to create a magnetic field in the chamber 14 which has a component B_{z} that is directed substantially along the longitudinal axis 16. Additionally, the filter 10 includes a plurality of voltage control rings 20, of which the voltage rings 20a-c are representative. As shown these voltage control rings 20a-c are located at one end of the cylindrical shaped wall 12 and lie generally in a plane that is substantially perpendicular to the longitudinal axis 16. With this combination, a radially oriented electric field, Eᵣ, can be generated.

For the plasma mass filter 10 of the present invention, the magnetic field B_{z} and the electric field Eᵣ are specifically oriented to create crossed electric magnetic fields. As is well known to the skilled artisan, crossed electric magnetic fields cause charged particles (i.e. ions) to move on helical paths, such as the path 22 shown in FIG. 1. The plasma mass filter 10 for the present invention requires that the voltage, along the longitudinal axis 16, V_{ctr}, be a positive voltage, compared to the voltage at the wall 12 which will normally be a zero voltage.

In the operation of the plasma mass filter 10, a rotating multi-species plasma 24 is injected into the chamber 14. Under the influence of the crossed electric magnetic fields, charged particles confined in the plasma 24 will travel generally along helical paths around the longitudinal axis 16 similar to the path 22. More specifically, as shown in FIG. 1, the multi-species plasma 24 includes charged particles which differ from each other by mass. Due to the fact that the elements of the nuclear waste may not be known, it is contemplated for the present invention that the plasma 24 includes at least two different kinds of charged particles, namely high-mass particles 26 (radioactive elements) and low-mass particles 28 (non-radioactive elements and glass contaminants).

Due to the configuration of the crossed electric magnetic fields and, importantly, the positive voltage V_{ctr} along the longitudinal axis 16, the plasma mass filter 10 causes charged particles in the multi-species plasma 24 to behave differently, according to their mass, as they transit the chamber 14. Specifically, charged high-mass particles 26 are not able to transit the chamber 14 and, instead, they are ejected into the wall 12. On the other hand, charged low-mass particles 28 are confined in the chamber 14 during their transit through the chamber 14. Thus, the low-mass particles 28 exit the chamber 14 and are, thereby, effectively separated from the high-mass particles 26. After the high-mass particles 26 (radioactive elements) are separated from the low-mass particles 28 (non-radioactive elements and contaminants) they are then collected from the wall 12 of the plasma mass filter 10 for subsequent vitrification.

The demarcation between low-mass particles 28 and high-mass particles 26 is a cut-off mass, M_{c}, which can be established for a parabolic voltage profile by the expression:

M_{c}=zea²(B_{z})²/8V_{ctr}.

In the above expression, “ze” is the charge on an electron, “a” is the radius of the chamber 14, “B_{z}” is the magnitude of the magnetic field, and “V_{ctr}” is the positive voltage which is established along the longitudinal axis 16. Of these variables in the expression, “ze” is a known constant. On the other hand, “a”, “B_{z}” and “V_{ctr}” can all be specifically established for the operation of plasma mass filter 10.

Referring now to FIG. 2, a heating apparatus for vitrifying the high-mass particles 26 after they have been removed from the chamber 14 is shown and generally designated 30. As shown, the heating apparatus 30 includes a plurality of induction coils 32, of which the induction coils 32a-d are only exemplary. Further, each induction coil 32a-d is connected via a respective conductor 34a-d to a power source 36.

In FIG. 2, it is also seen that the heating apparatus 30 includes a plurality of crucibles 38, of which the crucibles 38a-d are exemplary. Referring now to FIG. 3, and using the crucible 38a as an example, it is to be appreciated that each crucible 38 has a wall 40. Further, the wall 40 is made of three components that include an inner layer of alumina 42 (or some other material that withstands high temperature and is chemically inert), an intermediate layer of graphite 44 (or some similar material that withstands high temperature and absorbs inductive power), and an outer surface layer of stainless steel 46. As shown, the wall 40 of crucible 38 defines a hollow cavity (compartment) 48. Additionally, the crucible 38 can include a lid 50 which will enclose the hollow cavity (compartment) 48. As intended for the present invention, and indicted in FIG. 2, each induction coil 32 is dimensioned for selectively receiving a respective crucible 38, such that the coil 32 is positioned in a surrounding relationship relative to the crucible 38. Consequently, upon activation of the power source 36, the induction coils 32a-d will heat the respective crucibles 38 and whatever contents are in the hollow cavity (compartment) 48 of the crucible 38.

Still referring to FIG. 2, it is seen that a crucible 38 (exemplified by the crucible 38a) can be water-cooled. Specifically, for this purpose, a water source 52 can be provided to feed water through a supply line 54 and through a coil 56 that surrounds the crucible 38a. A return line 58 can also be provided to return water to the water source 52 for recycling. As intended for the present invention, this embodiment of the present invention allows the crucible 38 to be operated as a so-called “cold crucible” to achieve elevated temperatures.

In the operation of the present invention, the high-mass particles 26 are collected from the chamber 14 of the plasma mass filter 10, as indicated above, and placed in the crucibles 38, along with a frit 60. Power source 36 is then activated, and the induction coils 32 are heated to approximately 1600° C., or higher (nearer 2000° C. for a “cold crucible”). During the heating of the crucibles 38, the high-mass particles 26 will fuse with the frit 60 to form a melted mixture. This mixture is then cooled. As a result, the nuclear waste is encapsulated in solidified glass and the crucibles 38 containing this vitrified nuclear waste are subsequently discarded.

Using the “cold crucible” embodiment as disclosed and indicated above, higher melt temperatures may be attainable within the crucible 38. Specifically, this may be desirable as optimal conditions will exist when the melted mixture is near the thermal limit. For this condition, the thermal limit can be defined as the point where the vitrified high-mass particles 26 in the melted mixture begin to break down the glass. The point being that (for higher efficiencies) it is desirable to operate as close to the thermal limit as is possible.

While the particular System and Method for Radioactive Waste Vitrification as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for increasing the waste loading of vitrified waste which comprises the steps of:
separating particles of a multi-species plasma from each other in a chamber of a plasma mass filter, said multi-species plasma including low-mass particles (M₁) and high-mass particles (M₂);
collecting said high-mass particles (M₂) from said chamber as a relatively high concentration of radioactive elements;
placing a frit and said relatively high concentration of radioactive elements into each of a plurality of crucibles;
induction heating each said crucible for fusion of said relatively high concentration of radioactive elements with said frit to form a melted mixture having a relatively high waste loading; and
cooling said mixture in each said crucible to form said vitrified waste having said relatively high waste loading.

2. A method as recited in claim 1 wherein each said crucible comprises an inner layer of alumina, an intermediate layer of graphite and an outer layer of stainless steel.

3. A method as recited in claim 2 wherein said outer layer of said crucible has an outer surface, and wherein said method includes at least one induction coil mounted on said outer surface of said crucible for accomplishing said induction heating step.

4. A method as recited in claim 3 wherein each said crucible heats to approximately 1600° C. to fuse said frit with said relatively high concentration of radioactive elements.

5. A method as recited in claim 1 wherein said relatively high concentration of radioactive elements in a volume of said vitrified waste has a thermal limit.

6. A method as recited in claim 1 further comprising a wall surrounding said chamber of said plasma mass filter, said chamber defining a longitudinal axis, and further wherein said separating step is accomplished by an electric field being crossed with a magnetic field (E x B) in said chamber to eject said high-mass particles (M₂) into said wall and for confining said low-mass particles (M₁) in said chamber to separate said low-mass particles (M₁) from said high-mass particles (M₂).

7. A method as recited in claim 6 wherein “ze” is the charge of the particle, wherein said wall is at a distance “a” from said axis, wherein said magnetic field has a magnitude “B” in a direction along said longitudinal axis, wherein said positive potential on said longitudinal axis has a value “Vctr”, wherein the potential falls parabolically and said wall has a substantially zero potential, and wherein said low-mass particle (M₁) has a mass less than M_{c}, where M_{c}=zea²(B₂)²/8V_{ctr}.

8. A method for vitrifying waste of high-mass particles (M₂) comprising the steps of:
generating a magnetic field, said magnetic field being aligned substantially along and parallel to an axis;
generating an electric field substantially perpendicular to said magnetic field to create crossed magnetic and electric fields, said electric field directed outward with a positive potential on said longitudinal axis and a substantially zero potential at a distance from said axis;
injecting a multi-species plasma into said crossed magnetic and electric fields to interact therewith for ejecting said high-mass particles (M₂) away from said axis and for confining low-mass particles (M₁) within said distance from said axis during transit of said low-mass particles (M₁) along said axis to separate said low-mass particles (M₁) from said high-mass particles (M₂);
collecting said high-mass particles (M₂) from said plasma mass filter as a relatively high concentration of radioactive elements;
providing a plurality of crucibles, each said crucible having an inner layer of alumina, an intermediate layer of graphite, and an outer layer of stainless steel;
placing a frit and said relatively high concentration of radioactive elements in each said crucible;
induction heating said plurality of crucibles for fusion of said frit with said relatively high concentration of radioactive elements to form a mixture having a relatively high waste loading; and
cooling said plurality of crucibles to vitrify said waste of relatively high concentration of radioactive elements.

9. A method as recited in claim 8 wherein “ze” is the charge of the particle, wherein said wall is at a distance “a” from said axis, wherein said magnetic field has a magnitude “B” in a direction along said longitudinal axis, wherein said positive potential on said longitudinal axis has a value “V_{ctr}”, wherein said wall has a substantially zero potential, and wherein said low-mass particle (M₁) has a mass less than M_{c}, where M_{c}=zea²(B₂)²/8V_{ctr}.

10. A method as recited in claim 9 further comprising the step of varying said magnitude (B_{z}) of said magnetic field to alter M_{c}.

11. A method as recited in claim 8 wherein said outer layer of each said crucible has an outer surface, and further wherein said heating step is accomplished by an induction coil mounted on said outer surface of each said crucible.

12. A method as recited in claim 11 wherein each said crucible is heated to approximately 1600° C. to fuse said frit with said relatively high concentration of radioactive elements.

13. A system for increasing the waste loading of vitrified waste which comprises:
a plasma mass filter for separating low-mass particles (M₁) from high-mass particles (M₂), said high-mass particles (M₂) include a relatively high concentration of radioactive elements;
a plurality of crucibles for vitrifying said relatively high concentration of radioactive elements, each said crucible having an outer layer of stainless steel, an intermediate layer of graphite, and an inner layer of alumina;
a frit placed in each said crucible;
a means for placing said high-mass particles (M₂) in each said crucible with said frit; and
a means for heating each said crucible to fuse said frit with said high-mass particles (M₂) to form a melted mixture having a relatively high waste loading.

14. A system as recited in claim 13 further comprising a means for cooling said melted mixture in each said crucible to form said vitrified waste having said relatively high waste loading.

15. A system as recited in claim 13 wherein said heating means is at least one induction coil mounted on said outer layer of each said crucible.

16. A system as recited in claim 15 wherein each said crucible heats to approximately 1600° C. to fuse said frit with said relatively high concentration of radioactive elements.

17. A system as recited in claim 13 wherein said plasma mass filter further comprises:
a cylindrical shaped wall surrounding a chamber, said chamber defining a longitudinal axis;
means for generating a magnetic field in said chamber, said magnetic field being aligned substantially parallel to said longitudinal axis;
means for generating an electric field substantially perpendicular to said magnetic field to create crossed magnetic and electric fields, said electric field having a positive potential on said longitudinal axis and a substantially zero potential on said wall; and
means for injecting said rotating multi-species plasma into said chamber to interact with said crossed magnetic and electric fields for ejecting said high-mass particles (M₂) into said wall and for confining said low-mass particles (M₁) in said chamber during transit therethrough to separate said low-mass particles (M₁) from said high-mass particles (M₂).

18. A system as recited in claim 17 wherein said wall is at a distance “a” from said longitudinal axis, wherein said magnetic field has a magnitude “B_{z}” in a direction along said longitudinal axis, wherein said positive potential on said longitudinal axis has a value “V_{ctr}”, wherein the voltage drops parabolically until said wall has a substantially zero potential, and wherein said low-mass particle (M₁) has a mass less than M_{c}, where
M_{c}=zea²(B_{z})²/8V_{ctr}.

19. A system as recited in claim 17 wherein said means for generating said magnetic field is a magnetic coil mounted on said wall, and further wherein said means for generating said electric field is a series of conducting rings mounted on said longitudinal axis at one end of said chamber.
